(19) United States
(12) Patent Application Publication
(10) Pub. No.: US 2020/0089016 A1
(43) Pub. Date: Mar. 19, 2020

(54) HIGH BRIGHTNESS STEREOSCOPIC 3D PROJECTION SYSTEM

(71) Applicant: VOLFONI R&D, Villeneuve-Loubet (FR)

(72) Inventor: Stephen PALMER, Borlange (SE)

(73) Assignee: VOLFONI R&D, Villeneuve-Loubet, OT (unknown)

(21) Appl. No.: 16/574,903

(22) Filed: Sep. 18, 2019

Related U.S. Application Data
(60) Provisional application No. 62/733,216, filed on Sep. 19, 2018.

(51) Int. Cl. G02B 27/26; G02B 27/22; G02B 27/28

(52) U.S. Cl. CPC G02B 27/26; G02B 27/283; G02B 27/281; G02B 27/2264

(57) ABSTRACT

The present invention relates to a time-multiplexed stereoscopic 3d projection system that provides a higher level of on-screen image-brightness and image quality as compared to other prior-art technologies based on a single-beam architecture. The invention is based on the insight that a polarization beam-splitting element can be arranged to split an incident image-beam generated by a projector into one transmitted image-beam and at least one reflected image-beam, wherein each of said transmitted and reflected image-beams possess the same common state of polarization. Furthermore, by utilization of at least one reflecting surface, polarization rotator, polarization modulator, polarization-preserving projection-screen and passive polarized viewing-glasses, a stereoscopic 3d projection system is disclosed that provides for a high level of on-screen image-brightness and image quality.

### CROSS-REFERENCE TO RELATED APPLICATION

This application claims the benefit of priority to U.S. Provisional Application No. 62/733,216, filed Sep. 19, 2018, which is incorporated herein by reference.

### FIELD OF INVENTION

The present invention relates to a stereoscopic three dimensional (3d) projection system offering a high level of image-brightness, and more specifically to a time-multiplexed stereoscopic 3d projection system using a high-speed single-lens projector.

### BACKGROUND ART

Stereoscopic three dimensional (3d) projection systems have been used for many years. One technology known to the art and described in U.S. Pat. No. 7,528,906 dated Jan. 23, 2006 and entitled “Achromatic Polarization Switches”, describes how a polarization modulator can be placed in-front of a single-lens projector, such as a 3-chip DLP digital cinema projector or otherwise.

The projector is arranged so as to generate a single image-beam comprising a rapid succession of alternate left and right-eye images at high speeds of typically 144 Hz (hertz). The polarization modulator imparts an optical polarization state to images generated by said projector and moreover said polarization modulator is operated in synchronization with the images generated by said projector in order to arrange for all left-eye images to possess a first state of circular polarization and all right-eye images to possess a second state of circular polarization, with said first and second states of circular polarization being mutually orthogonal (i.e. possessing opposite senses of rotation, for example with said first polarization state comprising clockwise or right-handed circular polarization and said second polarization state comprising anticlockwise or left-handed circular polarization).

Thereafter, said left and right-eye images are focused onto the surface of a polarization-preserving projection-screen such as a silver-screen or otherwise, thereby enabling the viewing of time-multiplexed stereoscopic 3d images via utilization of passive circular-polarized viewing-glasses. It will be known to one skilled-in-the-art that the utilization of passive circular-polarized viewing-glasses enables the observer to tilt their head without there being a significant reduction in the optical performance of said stereoscopic 3d projection system. It is therefore for this reason the majority of passive stereoscopic 3d projection systems currently on the market are based on circular polarization according to the state-of-the-art.

Furthermore, it will be known to one skilled-in-the-art that said polarization modulator may comprise of at least one or more liquid crystal elements stacked together in series in order to achieve the required electro-optical switching characteristics. One technology known to the art is described in U.S. Pat. No. 7,477,206 dated Dec. 6, 2005 and entitled “Enhanced ZScreen modulator techniques”. Here, it is described how said polarization modulator may comprise of two individual Pi-cell liquid crystal elements stacked together in mutually crossed orientation such that the surface alignment-directors in the first Pi-cell are orthogonal to the surface alignment-directors in the second Pi-cell thereof. Pi-cell liquid crystal elements are known to the art and characterized by their surface alignment-directors on each substrate being aligned mutually parallel. Therefore, in at least one optical state the liquid crystal materials composing said Pi-cell form a helical structure between said substrates with an overall twist of 180 degrees (i.e. Pi or π radians). A detailed description of the design and function of Pi-cell liquid crystal elements can be found elsewhere in the literature according to the prior-art.

Moreover, each Pi-cell liquid crystal element can, for example, be rapidly switched between a first optical state possessing an optical retardation value that is substantially equal to zero when driven with high voltage (e.g. 25 volt) in order to switch said liquid crystal materials to the homeotropic texture, and a second optical state possessing an optical retardation value that is substantially equal to 140 nm (nanometers) when driven with a low voltage (e.g. 3 volt) in order to switch said liquid crystal materials to the splay texture. The homeotropic texture is characterized by the molecular axes of said liquid crystal materials being aligned substantially perpendicular to the surfaces of said substrates, whereas the splay texture is characterized by said molecular axes being aligned substantially parallel with said substrates and furthermore wherein the twist within said liquid crystal materials is substantially equal to zero. Moreover, said Pi-cell liquid crystal elements are capable of being rapidly switched between said first and second optical polarization states within a time period of typically less than 250 μs (microseconds) and are therefore typically used when designing such polarization modulators according to the state-of-the-art.

It will also be known to one skilled-in-the-art that when said Pi-cell liquid crystal element possesses a retardation value substantially equal to 140 nm, then said Pi-cell constitutes an optical Quarter-Wave-Plate (QWP) for the central part of the visible wavelength spectrum (i.e. green) and will therefore convert incident linearly polarized visible light to circular polarization. Therefore, by stacking together two individual Pi-cell liquid crystal elements in mutually crossed orientation together with a linear polarization-filter located at the entrance surface of said stack in order to first convert the initially randomly polarized (i.e. unpolarized) incident light generated by said projector to linear polarization, then the images generated by said projector can be rapidly modulated between left and right circular polarization states by operating said Pi-cell liquid crystal elements mutually out-of-phase according to the state-of-the-art. Specifically, when said first Pi-cell is operated with high voltage (i.e. liquid crystal materials are switched to said homeotropic texture) then said second Pi-cell is simultaneously operated with low voltage (i.e. liquid crystal materials are switched to said splay texture), and vice versa according to the prior-art.

However, since the images generated by a typical 3-chip DLP digital cinema projector are initially randomly polarized, then the linear polarization-filter located at the entrance surface of said polarization modulator will absorb approximately 50% of the incoming light initially generated by said projector. This will therefore significantly reduce the overall optical light efficiency of said stereoscopic 3d projection system based on the aforementioned single-beam architecture according to the state-of-the-art, thereby resulting in the creation of stereoscopic 3d images that are severely lacking in on-screen image-brightness.

### SUMMARY OF THE INVENTION

An object of the present invention is to provide a stereoscopic 3d projection system offering a higher on-screen image-brightness as compared to the aforementioned single-beam system according to the state-of-the-art. A further object of the present invention is to provide a stereoscopic 3d image with higher image quality as compared to that offered by other prior-art technologies.

The invention is based on the insight that the randomly polarized incident image-beam generated by a projector can be split into at least two spatially separated image-beams via utilization of a Polarization Beam-Splitting (PBS) element arranged accordingly, for example but not limited to one transmitted image-beam propagating in a direction toward the surface of a polarization-preserving projection-screen and at least one reflected image-beam, wherein each of said transmitted and reflected image-beams possess a first common state of polarization. A reflecting surface is additionally arranged to deflect the optical-path of said reflected image-beam in order to create a deflected image-beam propagating toward the surface of said projection-screen. Thereafter, polarization rotators located within the optical-paths for each of said transmitted and reflected image-beams transform the polarization states for said image-beams to a second common state of polarization, wherein said second common state of polarization may or may not be substantially different to said first common state of polarization. One or more polarization modulators are then arranged so as to rapidly modulate the polarization states of said transmitted and reflected image-beams between a first and second modulated output polarization state in synchronization with the images generated by said projector, wherein said first and second modulated output polarization states are mutually orthogonal. A stereoscopic 3d image can thereby be viewed on the surface of said projection-screen via utilization of suitable passive polarized viewing-glasses. Moreover, it will be understood by one skilled-in-the-art that the disclosed invention permits all polarization states composing said original incident image-beam generated by said projector to be utilized in order to recreate a complete stereoscopic 3d image on the surface of said projection-screen thereof, thereby generating a stereoscopic 3d image with a higher level of image-brightness and improved quality as compared to the aforementioned system based on a single-beam architecture according to the prior-art.

In a first preferred embodiment of the present invention, said first common state of polarization is linear polarization characterized by the electric-field vector being aligned at +45 degrees (plus) in an anticlockwise direction relative to the horizontal direction (wherein said horizontal direction is also perpendicular to the direction of light propagation for said transmitted image-beam thereof), and said second common state of polarization is P-State linear polarization characterized by the electric-field vector being aligned vertically (which is also perpendicular to said horizontal direction thereto). Additionally, said first and second modulated output polarization states are both circular polarization states (i.e. clockwise and anticlockwise circular polarization states), thereby enabling a stereoscopic 3d image to be viewed on the surface of a polarization-preserving projection-screen via utilization of passive circular-polarized viewing-glasses.

### BRIEF DESCRIPTION OF THE FIGURES

The present invention may be better understood and its objects and advantages will become apparent to one skilled-in-the-art by reference to the accompanying drawings, wherein like reference numerals refer to like elements in several of the figures.

FIG. 1: Stereoscopic 3d projection system based on a single-beam architecture according to the prior-art.

FIG. 2: Stereoscopic 3d projection system based on a double-beam architecture according to the prior-art.

FIG. 3: Stereoscopic 3d projection system based on an alternative double-beam architecture according to the prior-art.

FIG. 4: Stereoscopic 3d projection system based on a triple-beam architecture according to the prior-art.

FIG. 5: Stereoscopic 3d projection system based on an alternative triple-beam architecture according to the prior-art.

FIG. 6: Stereoscopic 3d projection system based on a double-beam architecture according to a first preferred embodiment of the present invention.

FIG. 7: Detailed design of a stereoscopic 3d projection system based on a double-beam architecture according to said first preferred embodiment of the present invention.

FIG. 8: Stereoscopic 3d projection system based on a triple-beam architecture according to a second preferred embodiment of the present invention.

### DETAILED DESCRIPTION OF THE INVENTION

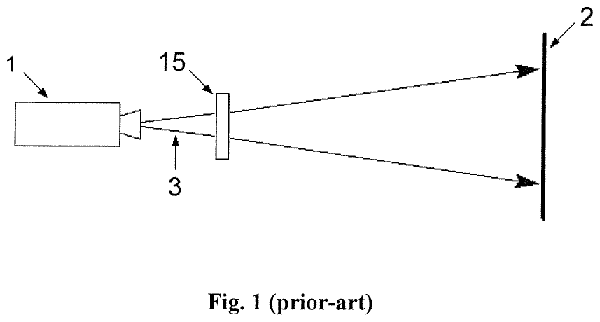

FIG. 1 shows a stereoscopic 3d projection system based on a single-beam architecture according to the state-of-the-art comprising a projector 1 arranged to generate a randomly polarized incident image-beam 3 comprising a succession of alternate left and right-eye images. A polarization modulator 15 is located within the optical-path of said incident image-beam 3 and operated in synchronization with the images generated by said projector 1 in order to impart a first polarization state to all left-eye images (e.g. left circular polarized) and a second polarization state to all right-eye images (e.g. right circular polarized), wherein said first and second polarization states are mutually orthogonal. A polarization modulator is a dynamic optical element that can be used to rapidly switch the polarization state of an image-beam between at least two different states of polarization in response to an externally applied voltage-signal (not shown).

The left and right-eye images are focused onto the surface of a polarization-preserving projection-screen 2, such as but not limited to a silver-screen or otherwise, thereby allowing time-multiplexed stereoscopic 3d images to be viewed on the surface of said projection-screen via utilization of passive circular-polarized viewing-glasses (not shown).

It will be known to one skilled-in-the-art that said polarization modulator 15 may preferably comprise of at least two individual liquid crystal elements (not shown) bonded together in series, such as but not limited to Pi-cell liquid crystal elements or otherwise. Furthermore, since the incident image-beam 3 generated by said projector 1 is typically randomly polarized, then a linear polarization-filter (not shown) is also required to be located in close proximity to the entrance surface of said polarization modulator 15 in order to pre-polarize the incoming light before reaching said liquid crystal elements thereto. Moreover, since the optical transmission of said polarization-filter is typically less than 50% for an incident image-beam 3 that is initially randomly polarized, then it will be known to one skilled-in-the-art that said stereoscopic 3d projection system based on a single-beam architecture according to the prior-art will create a stereoscopic 3d image that is severely lacking in on-screen image-brightness.

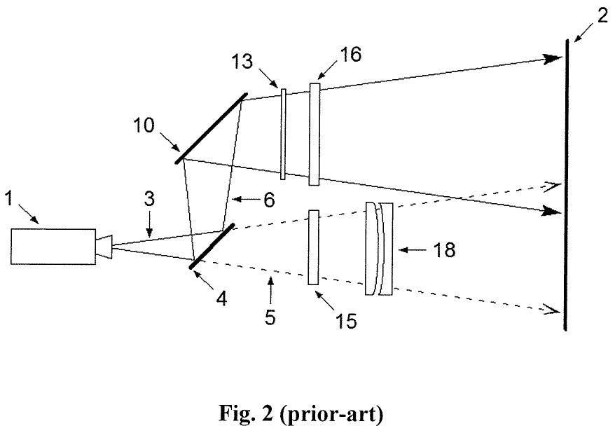

FIG. 2 shows a stereoscopic 3d projection system according to the state-of-the-art that provides for a higher on-screen image-brightness as compared to the aforementioned prior-art system based on a single-beam architecture. This system uses a double-beam architecture and is described in U.S. Pat. No. 7,857,455 dated Oct. 18, 2006 and entitled “Combining P and S rays for bright stereoscopic projection”, and also in U.S. Pat. No. 8,220,934 dated Sep. 29, 2006 and entitled “Polarization conversion systems for stereoscopic projection”.

Here, a randomly polarized incident image-beam 3 comprising a succession of alternate left and right-eye images generated by a single-lens projector 1 is arranged to impinge on the surface of a polarization beam-splitting element 4. The polarization beam-splitting element separates said incident image-beam 3 into one transmitted image-beam 5 propagating in the same direction as said incident image-beam 3 and possessing a first state of linear polarization (e.g. P-State), and one reflected image-beam 6 propagating in a direction substantially perpendicular to said incident image-beam 3 and possessing a second state of linear polarization (e.g. S-State), wherein said first and second states of linear polarization are mutually orthogonal.

A reflecting surface 10, such as a silver-mirror or otherwise, is used to deflect the optical-path of said reflected image-beam 6 toward the surface of a polarization-preserving projection-screen 2, thereby enabling both said transmitted and reflected image-beams 5, 6 thereof to be arranged so as to mutually overlap to a substantial extent on the surface of said projection-screen. This system therefore permits all polarization components composing said original incident image-beam 3 generated by said projector 1 to be used in order to recreate the overall on-screen stereoscopic 3d image, thereby increasing the resulting image-brightness.

Additionally, a polarization rotator 13 is required in order to rotate the linear polarization state of said reflected image-beam 6 by substantially 90 degrees and thereby ensuring that both said transmitted and reflected image-beams 5, 6 thereafter possess the same linear state of polarization (e.g. P-State). A polarization rotator is a static optical element that is capable of rotating the polarization state of an image-beam.

Furthermore, polarization modulators 15, 16 are respectively located within the optical-paths for each of said transmitted and reflected image-beams 5, 6 thereof and operated in synchronization with the images generated by said projector 1 in order to ensure all left-eye images possess a first state of circular polarization and all right-eye images possess a second state of circular polarization, wherein said first and second states of circular polarization are mutually orthogonal. Stereoscopic 3d images can thereby be viewed on the surface of said projection-screen via utilization of passive circular-polarized viewing-glasses (not shown).

However, the double-beam system described above according to the state-of-the-art has the disadvantage in that there is a relatively large optical path-length difference between said transmitted and reflected image-beams 5, 6 thereof, thereby typically requiring the additional use of a telephoto-lens pair 18 in order to compensate for said optical path-length difference. A telephoto-lens is an optical lens that possesses a relatively long focal-length and which can focus a mutually parallel light-beam to substantially a single point (i.e. focal-point). The telephoto-lens is therefore mandated to have at least one surface that is simultaneously curved around two mutually orthogonal axes in order to create a spherical or ellipsoidal surface, for example with said surface being simultaneously curved around both the horizontal and vertical axes. However, such spherical or ellipsoidal lenses typically suffer from the occurrence of a high level of optical aberration and are also relatively difficult to manufacture which adds both complexity and expense to the overall system.

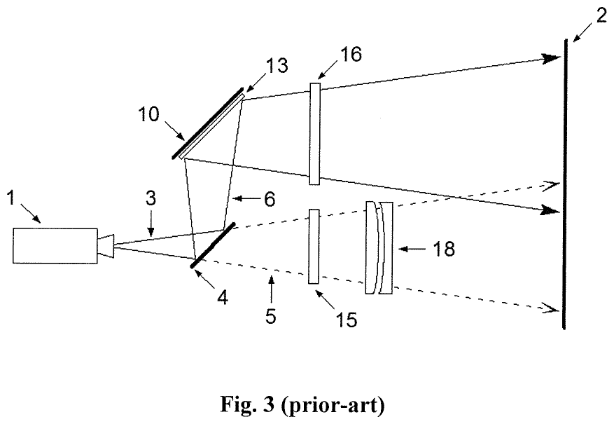

FIG. 3 shows an alternative stereoscopic 3d projection system based on a double-beam architecture according to the state-of-the-art which provides a minor modification relative to that shown in FIG. 2 wherein the polarization rotator 13 (i.e. phase shifting optic) is now bonded to the front surface of the reflecting mirror 10. This embodiment is described in U.S. Pat. No. 9,494,805 dated Jan. 21, 2014 and entitled “Stereoscopic light recycling device”. However, the function and operation of this modified design is essentially identical to that previously described above, wherein identical elements have been denoted using the same numerals in both FIG. 2 and FIG. 3 thereof Specifically, it is noted the polarization states of the transmitted image-beam 5 (e.g. P-State) and reflected image-beam 6 (e.g. S-State) are mutually orthogonal, and furthermore the polarization rotator 13 (i.e. phase shifting optic) transforms the polarization state of the reflected image-beam 6 to that of the transmitted image-beam 5, thereby ensuring each of said transmitted and reflected image-beams 5, 6 thereafter have the same common state of polarization (e.g. P-State). Additionally, polarization modulators 15, 16 are respectively located within the optical-paths for each of said transmitted and reflected image-beams 5, 6 thereof and arranged so as to rapidly modulate the polarization states between a first and second state of circular polarization, wherein said first and second states of circular polarization are mutually orthogonal. This thereby enables time-multiplexed stereoscopic 3d images to be viewed on the surface of said projection-screen via utilization of passive circular-polarized viewing-glasses (not shown).

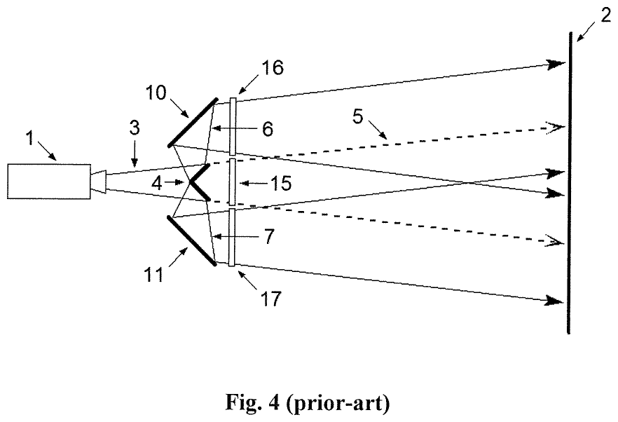

FIG. 4 shows an improved system for the displaying of time-multiplexed stereoscopic 3d images possessing a high level of image-brightness according to the state-of-the-art. Here, a stereoscopic 3d projection system based on a triple-beam architecture is provided and described in U.S. Pat. No. 9,958,697 dated Apr. 2, 2013 and entitled “Stereoscopic image apparatus”, and also in U.S. Pat. No. 9,740,017 dated May 29, 2013 and entitled “Optical polarization device for a stereoscopic image projector”.

Here, the randomly polarized incident image-beam 3 comprising a succession of alternate left and right-eye images generated by a single-lens projector 1 impinges on the surface of a polarization beam-splitting element 4. The polarization beam-splitting element 4 separates said incident image-beam 3 into one transmitted image-beam 5 propagating in the same direction as said incident image-beam 3 and possessing a first state of linear polarization (e.g. P-State), and two reflected image-beams 6, 7 propagating in mutually opposite directions that are also both substantially perpendicular to the propagating direction of said incident image-beam 3 and possessing a common second state of linear polarization (e.g. S-State), wherein said first and second linear polarization states are mutually orthogonal. The polarization beam-splitting element 4 typically comprises of two plates joined together along a common edge to form a chevron or V-shape structure and with the connecting edge for each of said plates being beveled at an angle substantially equal to 45 degrees in order to allow both said plates to be placed together in close proximity according to the state-of-the-art.

Thereafter, reflecting surfaces 10, 11 such as silver-mirrors or otherwise are used to deflect the optical-paths for each of said reflected image-beams 6, 7 thereof toward a polarization-preserving projection-screen 2 and arranged such that said transmitted image-beam 5 and each of said reflected image-beams 6, 7 at least partially overlap in order to recreate a complete image on the surface of said projection-screen thereof. This permits all polarization components composing said original incident image-beam 3 generated by said projector 1 to be used in order to recreate the overall on-screen image, thereby ensuring for a higher level of image-brightness as compared to the previously described single-beam architecture according to the prior-art.

Additionally, polarization modulators 15, 16, 17 are respectively placed within the optical-paths for each of said transmitted image-beam 5 and both said reflected image-beams 6, 7 thereof and operated so as to modulate the polarization states of said image-beams in synchronization with the images generated by said projector 1. Specifically, said polarization modulators 15, 16, 17 are typically arranged so as to impart a first circular polarization state to all left-eye images and a second circular polarization state to all right-eye images, wherein said first and second circular polarization states are mutually orthogonal. This enables time-multiplexed stereoscopic 3d images to be viewed on the surface of said projection-screen 2 via utilization of passive circular-polarized viewing-glasses (not shown) according to the state-of-the-art.

It will be known to one skilled-in-the-art that the triple-beam architecture described above possesses a relatively small optical path-length difference between said transmitted and reflected image-beams as compared to the aforementioned double-beam system thereof, thereby eliminating the necessity of utilizing a telephoto-lens pair or otherwise in order to compensate for said optical path-length difference. This therefore reduces the overall complexity and cost of the system.

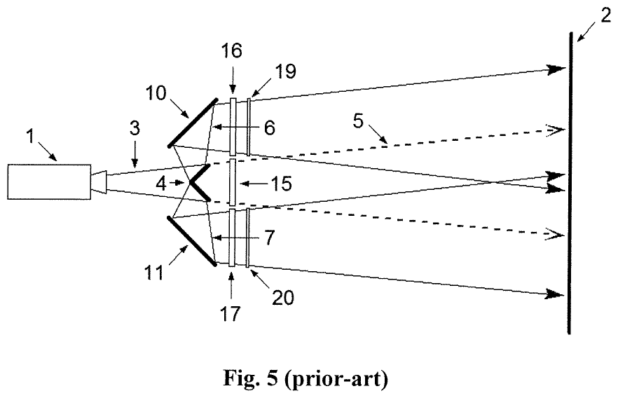

FIG. 5 shows an alternative time-multiplexed stereoscopic 3d projection system based on a triple-beam architecture according to the state-of-the-art. This design is described in U.S. Pat. No. 9,594,255 dated Jun. 25, 2015 and entitled “Stereoscopic 3d projection system with improved level of optical light efficiency”. Here, the randomly polarized incident image-beam 3 comprising a succession of alternate left and right-eye images generated by a single-lens projector 1 is arranged to impinge on the surface of a polarization beam-splitting element 4. The polarization beam-splitting element separates the incident image-beam 3 into one transmitted image-beam 5 propagating in the same direction as said incident image-beam 3 and possessing a first state of linear polarization (e.g. P-State), and two reflected image-beams 6, 7 propagating in mutually orthogonal directions which are also substantially perpendicular to the direction of propagation for said incident image-beam 3 and possessing a common second state of linear polarization (e.g. S-State), wherein said first and second states of linear polarization are mutually orthogonal.

There are also provided reflecting surfaces 10, 11 arranged to respectively deflect the optical-paths for each of said reflected image-beams 6, 7 thereof toward a polarization-preserving projection-screen 2, wherein said transmitted image-beam 5 and both said reflected image-beams 6, 7 are arranged to mutually overlap at least to a partial extent in order to recreate a complete image on the surface of said projection-screen thereto.

There are also provided polarization modulators 15, 16, 17 respectively located within the optical-paths for each of said transmitted image-beam 5 and both said reflected image-beams 6, 7 thereof and arranged to modulate the polarization states for each of said image-beams between a first and second circular polarization state, wherein said first and second circular polarization states are mutually orthogonal. Specifically, said polarization modulators 15, 16, 17 are arranged to ensure all left-eye images possess said first state of circular polarization and all right-eye images possess said second state of circular polarization, thereby enabling time-multiplexed stereoscopic 3d images to be viewed on the surface of said projection-screen via utilization of passive circular-polarized viewing-glasses (not shown). Furthermore, it will be known to one skilled-in-the-art that since all polarization states composing said original incident image-beam 3 are used to recreate the overall on-screen image, then said triple-beam system described herein will generate a stereoscopic 3d image with a higher level of on-screen image-brightness as compared to the aforementioned single-beam architecture according to the prior-art.

Additionally, there are also provided Optical Contrast Enhancement (OCE) films 19, 20 respectively located within the optical-paths for each of said reflected image-beams 6, 7 thereof and designed to improve the level of circular polarization, thereby increasing image contrast and reducing the level of perceived ghosting (i.e. image crosstalk). Furthermore, each of said optical contrast enhancement films 19, 20 may preferably each comprise a stack of at least three separate optical retardation films (not shown) bonded together in series, wherein each individual optical retardation film possesses a specific value of in-plane retardation and orientation of optical axis.

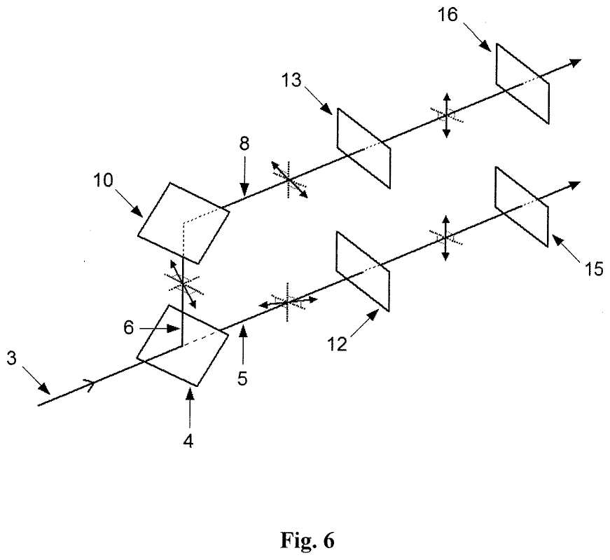

FIG. 6 shows a preferred embodiment of the present invention based on a double-beam architecture. Here, the initially randomly polarized incident image-beam 3 generated by a projector (not shown), such as but not limited to a DLP digital cinema projector, is arranged to impinge on a polarization beam-splitting element 4 such as a multi-layer stack of dielectric coatings deposited on the surface of a planar glass-substrate or otherwise and arranged such that said incident image-beam 3 is split into one transmitted image-beam 5 and at least one reflected image-beam 6, wherein both said transmitted image-beam 5 and reflected image-beam 6 possess a first common state of polarization.

In this figure and all underlying figures hereafter, the optical-paths for the individual image-beams are represented by single-line vectors for ease of clarity. However, it will be understood by one skilled-in-the-art that said image-beams typically possess some level of angular divergence, for example ±10 degrees in the vertical plane and ±20 degrees in the horizontal plane, respectively. However, it is to be understood that the occurrence of said beam divergence does not result in there being a departure from the inventive ideas disclosed herein and said divergence will therefore be omitted in the underlying drawings for ease of clarity.

The polarization beam-splitting element 4 is an optical device designed to split an incident image-beam into at least two spatially separated image-beams and may preferably comprise a multi-layer stack of dielectric coatings that may also incorporate optical coatings embedded within its layers that rotate the polarization of light. As such, the polarization states of the spatially separated image-beams can be adjusted to be almost any desired state of polarization and consequently the polarization beam-splitting element is not limited to only being able to divide an incident image-beam into two spatially separated image-beams possessing mutually orthogonal polarization states, such as S-State and P-State linear polarization. Alternatively, said polarization beam-splitting element 4 may instead include a Wire-Grid Polarizer (WGP) or other optical element that splits an incident image-beam into at least two spatially separated image-beams.

Thereafter, said reflected image-beam 6 is arranged to impinge on a reflecting surface 10 such as a multi-layer stack of dielectric coatings deposited on the surface of a planar glass substrate, silver-mirror or other suitable reflecting surface in order to create a deflected image-beam 8 that may or may not possess said first common state of polarization and which propagates in a direction substantially parallel with said transmitted image-beam 5 thereof.

There are also provided two polarization rotators 12, 13 respectively located within the optical-paths for each of said transmitted image-beam 5 and deflected image-beam 8 and arranged so as to transform the polarization states for each of said transmitted and deflected image-beams to a second common state of polarization, wherein said second common state of polarization may or may not be substantially different from said first common state of polarization.

It will be understood by one skilled-in-the-art that said polarization rotators 12, 13 may preferably each comprise a stack of at least three individual optical retardation-films (not shown) bonded together in series, wherein each of said retardation-films possess a value of in-plane retardation and orientation of optical-axis, and furthermore wherein said value of in-plane retardation and orientation of optical-axis for each of said retardation-films are optimized so as to enable said stack to rotate the state of polarization by the required amount with high optical efficiency and achromaticity. Other optical elements may also be used to generate the required rotation of polarization such as but not limited to liquid crystals, birefringent materials or other phase-shifting optics without departing from the inventive ideas disclosed herein.

There are also provided polarization modulators 15, 16 respectively located within the optical-paths for each of said transmitted image-beam 5 and deflected image-beam 8 and arranged so as to rapidly modulate the state of polarization for both said transmitted and deflected image-beams between a first and second modulated output polarization state in synchronization with the images generated by said projector, wherein said first and second modulated output polarization states are preferably both circular polarization states that are substantially mutually orthogonal. Furthermore, both said transmitted and deflected image-beams are arranged to have substantially the same modulated output polarization state at any given period of time.

It will be understood by one skilled-in-the-art that typical polarization modulators currently available on the market only generate pure circular polarization over a relatively narrow range of selected wavelengths typically close to the central part of the visible wavelength region (e.g. green) and that in general the light will be elliptically polarized for other wavelengths of light (e.g. red and blue). It is therefore to be understood that the term circular polarization as used herein shall refer to all elliptical polarization states that are not linear polarization states and which may or may not comprise of pure circular polarization states.

The polarization modulators 15, 16 may each preferably comprise a stack of one or more individual liquid crystal elements (not shown) bonded together in series, such as but not limited to Pi-cell liquid crystal elements, Twisted-Nematic (TN) liquid crystal elements, Optically Controlled Birefringent (OCB) liquid crystal elements, Super-Twisted-Nematic (STN) liquid crystal elements, Surface Mode Device (SMD) liquid crystal elements, or any combination thereof. Furthermore, the two polarization modulators 15, 16 may instead be mutually joined together along a common edge in order to form one larger polarization modulator that is simultaneously positioned within both optical-paths for each of said transmitted image-beam 5 and deflected image-beam 8 thereof without departing from the inventive ideas disclosed herein.

It will also be understood by one skilled-in-the-art that said polarization rotators 12, 13 may preferably be bonded to the entrance surfaces of their respective polarization modulators 15, 16 thereof, or alternatively said polarization rotator 13 may instead be bonded to the front surface of said reflecting surface 10 without departing from the inventive ideas disclosed herein.

Thereafter, both said transmitted image-beam 5 and deflected image-beam 8 are arranged to at least partially overlap on the surface of a polarization-preserving projection-screen (not shown) such as a silver-screen or otherwise in order to enable a time-multiplexed stereoscopic 3d image to be viewed on the surface of said projection-screen via utilization of passive circular-polarized viewing-glasses (not shown). Furthermore, it will be understood by one skilled-in-the-art that since all polarization components composing said original incident image-beam 3 are used to recreate the overall stereoscopic 3d image on the surface of said projection-screen according to the disclosed invention, then the overall on-screen image-brightness will be higher than that for a system based on the aforementioned single-beam architecture according to the state-of-the-art.

In a first preferred embodiment of the present invention, it is disclosed that said first common state of polarization is linear polarization with an electric-field vector aligned at an angle of +45 degrees (plus) in an anticlockwise direction relative to the horizontal direction as viewed in the direction of light propagation (wherein said horizontal direction is also perpendicular to the direction of light propagation for said transmitted image-beam 5 thereof). Furthermore, said second common state of polarization is P-State linear polarization with an electric-field vector being vertically aligned, which is also orthogonal to said horizontal direction thereof.

In this preferred embodiment, it will be understood that said polarization rotator 13 is required to rotate the state of linear polarization for said deflected image-beam 8 by −45 degrees (minus) in an anticlockwise direction as viewed in the direction of light propagation, and said polarization rotator 12 is required to rotate the state of linear polarization for said transmitted image-beam 5 by +45 degrees (plus) in an anticlockwise direction as viewed in the direction of light propagation.

In another preferred embodiment, it is disclosed that said first common state of polarization may be S-State linear polarization characterized by the electric-field vector being aligned horizontally and said second common state of polarization may be P-State linear polarization characterized by the electric-field vector being aligned vertically. Alternatively, each of said first and second common states of polarization may instead both be P-State linear polarization, or alternatively each of said first and second common states of polarization may both be S-State linear polarization according to further embodiments of the present invention.

It will also be understood by one skilled-in-the-art that an optional telephoto-lens pair (not shown) may or may not be located within the optical-path for said transmitted image-beam 5 in order to compensate for the difference in optical-path length between said transmitted image-beam 5 and deflected image-beam 8 without departing from the inventive ideas disclosed herein. Alternatively, an optional uniaxial-lens (i.e. cylindrical lens) or other type of optical lens system may instead be included in order to compensate for said difference in optical-path length.

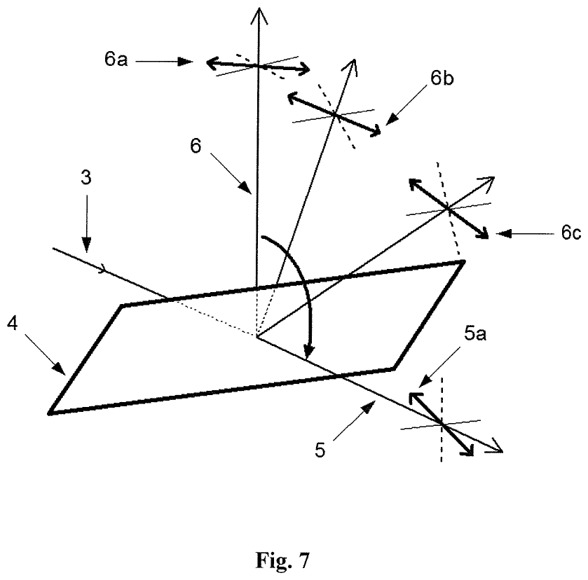

FIG. 7 shows further details of said first preferred embodiment of the present invention wherein the incident image-beam 3 impinges on said polarization beam-splitting element 4 with an angle-of-incidence (AOI) substantially equal to 45 degrees in order to create said transmitted image-beam 5 and said reflected image-beam 6. Furthermore, said transmitted image-beam 5 possesses a linear state of polarization characterized by the electric-field vector 5a, and said reflected image-beam 6 possesses a linear state of polarization characterized by the electric-field vector 6a. Moreover, it is demonstrated that the reflected image-beam 6 can be smoothly translated through the virtual states represented by 6b and 6c in order to be exactly superimposed on to said transmitted image-beam 5, whereupon both the direction of light propagation as well as the state of polarization for both said transmitted image-beam 5 and reflected image-beam 6 are thereafter identical, thereby confirming said transmitted and reflected image-beams have the same said first common state of polarization as disclosed herein.

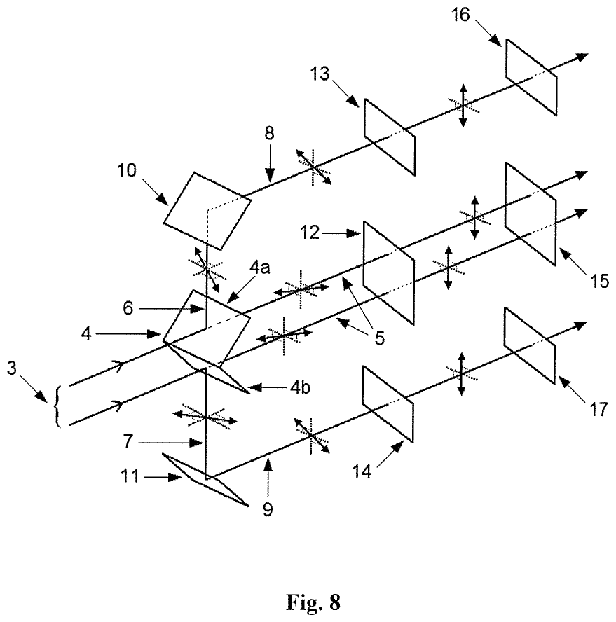

FIG. 8 shows an alternative preferred embodiment of the present invention based on a triple-beam architecture whereupon the incident image-beam 3 generated by a projector (not shown) impinges on a polarization beam-splitting element 4 in order to generate one transmitted image-beam 5 and two reflected image-beams 6, 7 wherein said reflected image-beams substantially propagate in mutually opposite directions which are also both substantially mutually orthogonal to the direction of light propagation for said transmitted image-beam 5 thereof, and furthermore wherein each of said transmitted image-beam 5 and both said reflected image-beams 6, 7 possess the same first common state of polarization.

The beam-splitting element 4 may preferably comprise of two separate plates 4a, 4b placed together along a common edge such as but not limited to planar glass substrates, and with there being a multi-layer stack of dielectric coatings (not shown) deposited onto the top surface of each of said plates or otherwise.

There are also provided reflecting surfaces 10, 11 arranged to respectively deflect the optical-paths for each of said reflected image-beams 6, 7 thereof in order to create two deflected image-beams 8, 9 that may or may not possess said first common state of polarization and which propagate in a direction that is substantially parallel with said transmitted image-beam 5 thereof.

Additionally, polarization rotators 12, 13, 14 are respectively located within the optical-paths for each of said transmitted image-beam 5 and both said deflected image-beams 8, 9 thereof in order to transform the polarization states for each of said transmitted and deflected image-beams to a second common state of polarization, wherein said second common state of polarization may or may not be substantially different from said first common state of polarization.

There are also provided polarization modulators 15, 16, 17 respectively located within the optical-paths for each of said transmitted image-beam 5 and both said deflected image-beams 8, 9 thereof and arranged so as to rapidly modulate the polarization states for said transmitted and deflected image-beams between a first and second modulated output polarization state in synchronization with the images generated by said projector, wherein said first and second modulated output polarization states are preferably circular polarization states that are substantially mutually orthogonal. Furthermore, both said transmitted and deflected image-beams are arranged to have substantially the same modulated output polarization state at any given period of time.

It will be understood by one skilled-in-the-art that at least two of said polarization modulators 15, 16, 17 may or may not be mutually joined together along a common edge in order to provide for one larger polarization modulator that is simultaneously located within the optical-paths for at least two of said transmitted and deflected image-beams thereof without departing from the inventive ideas disclosed herein. Furthermore, said polarization rotators 12, 13, 14 may preferably be directly bonded to the entrance surfaces of their respective polarization modulators 15, 16, 17 thereof. Alternatively, at least one of said polarization rotators 13, 14 may instead be bonded to the front surface of their respective reflecting surfaces 10, 11 thereto.

In a second preferred embodiment of the present invention, it is disclosed that said first common state of polarization is linear polarization characterized by the electric-field vector being aligned at +45 degrees (plus) in an anticlockwise direction relative to the horizontal direction as viewed in the direction of light propagation (wherein said horizontal direction is also perpendicular to the direction of light propagation for said transmitted image-beam 5 thereof). Furthermore, said second common state of polarization is P-State linear polarization characterized by the electric-field vector being aligned in a vertical direction, which is also perpendicular to said horizontal direction thereto.

In another preferred embodiment, it is disclosed that said first common state of polarization may be S-State linear polarization characterized by the electric-field vector being aligned horizontally and said second common state of polarization may be P-State linear polarization characterized by the electric-field vector being aligned vertically. Alternatively, each of said first and second common states of polarization may instead both be P-State linear polarization, or alternatively each of said first and second common states of polarization may both be S-State linear polarization according to further embodiments of the present invention.

Whilst preferred embodiments of the present invention have been shown and described herein, various modifications may be made thereto without departing from the inventive ideas of the present invention. Accordingly, it is to be understood that the present invention has been described by way of illustration and not limitation.

I/We claim:

1. A time-multiplexed stereoscopic 3d projection system comprising a polarization beam-splitting element arranged to split an incident image-beam generated by a projector into one transmitted image-beam propagating in a direction toward the surface of a polarization-preserving projection-screen, and a first reflected image-beam propagating in a direction substantially orthogonal to said transmitted image-beam, with there also being provided a first reflecting surface arranged to deflect the optical-path of said first reflected image-beam toward said projection-screen wherein each of said transmitted and first reflected image-beams possess a first common state of polarization.

2. A time-multiplexed stereoscopic 3d projection system according to claim 1 wherein there are provided first and second polarization rotators with one being located within the optical-path for each of said transmitted and first reflected image-beams and arranged to transform the polarization states of said image-beams to a second common state of polarization.

3. A time-multiplexed stereoscopic 3d projection system according to claim 1 further comprising first and second polarization modulators one being located within each of the optical-paths for said transmitted and first reflected image-beams and arranged to rapidly modulate the polarization states of said image-beams between a first and second modulated output polarization state in synchronization with the images generated by said projector, wherein said first and second modulated output polarization states are substantially mutually orthogonal.

4. A time-multiplexed stereoscopic 3d projection system according to claim 1 wherein said polarization beam-splitting element is further arranged to provide a second reflected image-beam propagating in a mutually opposite direction to said first reflected image-beam and with each of said transmitted image-beam and both said first and second reflected image-beams possessing the same said first common state of polarization.

5. A time-multiplexed stereoscopic 3d projection system according to claim 4 wherein there is provided a second reflecting surface arranged to deflect the optical-path of said second reflected image-beam toward the surface of said projection-screen.

6. A time-multiplexed stereoscopic 3d projection system according to claim 5 wherein there are provided first, second, and third polarization rotators with one being located within the optical-path for each of said transmitted image-beam and said first and second reflected image-beams and arranged to transform the polarization states of said image-beams to a second common state of polarization.

7. A time-multiplexed stereoscopic 3d projection system according to claim 5 further comprising first, second, and third polarization modulators with one being located within the optical-path for each of said transmitted image-beam and said first and second reflected image-beams and arranged to rapidly modulate the polarization states of said image-beams between a first and second modulated output polarization state in synchronization with the images generated by said projector wherein said first and second modulated output polarization states are substantially mutually orthogonal.

8. A time-multiplexed stereoscopic 3d projection system according to claim 1 wherein said first common state of polarization is linear polarization with electric-field vector aligned at +45 degrees in an anticlockwise direction relative to the horizontal direction as viewed in the direction of light propagation, with said horizontal direction also being orthogonal to the direction of light propagation for said transmitted image-beam thereof.

9. A time-multiplexed stereoscopic 3d projection system according to claim 1 wherein said first common state of polarization comprises of S-State linear polarization with electric-field vector aligned horizontally.

10. A time-multiplexed stereoscopic 3d projection system according to claim 1 wherein said first common state of polarization comprises of P-State linear polarization with electric-field vector aligned vertically.

11. A time-multiplexed stereoscopic 3d projection system according to claim 2 wherein said second common state of polarization comprises of P-State linear polarization with electric-field vector aligned vertically.

12. A time-multiplexed stereoscopic 3d projection system according to claim 1 wherein said polarization beam-splitting element comprises a multi-layer stack of dielectric coatings.

13. A time-multiplexed stereoscopic 3d projection system according to claim 1 wherein said first reflecting surface comprises a multi-layer stack of dielectric coatings.

14. A time-multiplexed stereoscopic 3d projection system according to claim 2 wherein at least one of said first and second polarization rotators comprise a stack of at least three individual optical retardation-films bonded together in series and with each of said retardation-films possessing a value of in-plane optical retardation and orientation of optical-axis.

15. A time-multiplexed stereoscopic 3d projection system according to claim 3 wherein at least one of said first and second polarization rotators is bonded to the entrance surface of at least one of said polarization modulators.

16. A time-multiplexed stereoscopic 3d projection system according to claim 2 wherein at least one of said first and second polarization rotators is bonded to the front surface of said first reflecting surface.

17. A time-multiplexed stereoscopic 3d projection system according to claim 3 wherein said first and second modulated output polarization states each comprise of circular polarization.

18. A time-multiplexed stereoscopic 3d projection system according to claim 3 wherein said first and second polarization modulators are mutually joined together along a common edge.
